(19) United States
(12) Patent Application Publication
(10) Pub. No.: US 2016/0195465 A1
(43) Pub. Date: Jul. 7, 2016

(54) METHOD FOR DETERMINING MODIFICATION OF POROUS MEDIUM PARAMETERS UNDER THE EFFECT OF A CONTAMINANT

(71) Applicant: SCHLUMBERGER TECHNOLOGY CORPORATION, Sugar Land, TX (US)

(72) Inventors: Dmitry Nikolaevich Mikhailov, Moscow (RU); Nikita Ilyich Ryzhikov, Moscow (RU); Alexander Alexandrovich Burukhin, Moscow (RU); Anna Victorovna Zharnikova, Moscow (RU)

(21) Appl. No.: 14/978,631

(22) Filed: Dec. 22, 2015

(30) Foreign Application Priority Data
Dec. 30, 2014 (RU) 2014153917

(51) Int. Cl. G01N 15/08; E21B 49/00

(52) U.S. Cl. CPC G01N 15/088; E21B 49/005

(57) ABSTRACT

A porous medium sample is initially saturated with a conductive fluid, or a conductive fluid and a non-conductive fluid at the same time, or a non-conductive fluid only. Measurements of electrical resistivity are taken in at least two places along the porous medium sample, and a flooding experiment is carried out with a contaminant solution injected through the porous medium sample. During or after the filtration experiment, second measurements of resistivity are carried out at the same places where the first measurement had been made. Measured data are used for computing a profile of rock saturation with filtrate and a ratio of a modified porosity to an initial porosity of the sample.

### CROSS-REFERENCE TO RELATED APPLICATION

This application claims priority to Russian Application No. 2014153917 filed Dec. 30, 2014, which is incorporated herein by reference in its entirety.

### BACKGROUND

The disclosure relates to a method for non-destructive analysis of porous material samples, in particular, it can be used for quantification of oil and gas formation damage in a near-wellbore zone of oil and gas-bearing formations caused by invasion of mud components.

The problem of the near-wellbore formation damage caused by invasion of drilling fluid (or circulating fluid) components is especially critical for long horizontal wells because most of them are open-hole completions, i.e. such wells are completed without cemented and perforated production casing.

Drilling fluids (muds) are complex mixtures of polymers, particles (with hundreds of microns to less than a micron in size), clays and other additives contained in a “carrier” fluid, which is a “base” of a drilling mud. The base can be either water, oil or a synthetic fluid.

When exposed to overpressure during drilling, drilling mud filtrate and fine particles, polymers and other ingredients can invade into the formation causing a significant reduction of rock porosity and permeability. A complicated structure is created in the near-wellbore zone, which normally consists of an external filter cake (deposited on a borehole wall and consisting of filtered solid particles), a packed wall zone (an internal filter cake) and a filtrate invaded zone.

During the well clean-up process (by slowly bringing the well on production), the external filter cake is destroyed, and the invaded components of the drilling fluid are partly washed away from the near-wellbore zone and its permeability is partly restored. Nevertheless, some mud components remain trapped in a pore space of the rock (by adsorption on pore surface, or seized in narrow pore channels) causing a difference between original permeability and permeability restored after the well clean-up procedure (normally, the restored permeability is up to 50-70% of the original permeability).

A commonly accepted laboratory method of evaluating a drilling mud quality is a flooding experiment when the drilling mud is injected into a core sample and then injected in the opposite direction (i.e. the invaded drilling mud is displaced by the original formation fluid). Measurements are made of decreasing and restoring permeability as a function of the amount of fluid (drilling mud or formation fluid) injected into a pore space.

However, this commonly accepted laboratory method only allows for measuring an integral flow resistance of a core sample, changes in which are caused by growth or destruction of the external filter cake on the core end and by build-up or wash-out of mud components in the rock.

Evidently, flooding experiment data are not sufficient for determining properties describing the dynamics of filtered admixture build-up in the pore space and properties of the packed wall zone. More information should be obtained.

In addition, damaged porosity and permeability profiles along core samples (along a filtration axis) after exposure to a drilling fluid and “restored” porosity and permeability profiles after backwashing provide important data for better understanding of formation damage mechanism and selecting the most appropriate method of improving well productivity index (for minimizing formation damage in the near-wellbore zone).

Other methods should be applied to determine this parameter.

U.S. Pat. No. 4,540,882 and U.S. Pat. No. 5,027,379 describe methods for determining drilling fluid penetration depth by X-ray computer tomography of a core with a contrast agent added to a drilling fluid base (“carrier fluid”). However, using the contrast agent dissolved in the “carrier fluid” does not allow for evaluating penetration depth of low-contrast additives contained in the drilling fluid because penetration depths of mud filtrate and most of the common additives (solid particles, polymers, clay) are generally different.

U.S. Pat. No. 5,253,719 proposes a method for diagnosing a formation damage mechanism by analyzing radially oriented core samples taken from a well. The core samples are analyzed under a number of analytical methods to determine the type and extent of formation damage and a distance the damage extends out into the formation. Among the analytical methods, the patent includes qualitative X-ray diffraction (XRD) analysis, X-ray micro-analysis, scanning electron microscope (SEM) analysis, backscattered electron microscopy, petrographic analysis, optical microscopy.

However, this method involves destruction of core samples and conducting rather time-consuming tests.

In order to obtain data on permeability dynamics along a porous medium sample when the sample is exposed to a drilling mud or when another contaminant is injected, a sample holder should be equipped with extra tubes for measuring pressure drop (Longeron D. G., Argillier J., Audibert A., An Integrated Experimental Approach for Evaluating Formation Damage Due to Drilling and Completion Fluids, 1995, SPE 30089; Jiao D., Sharma M. M., Formation Damage Due to Static and Dynamic Filtration of Water-Based Muds, 1992, SPE 23823).

U.S. Pat. No. 7,099,811 proposes to use an experimental apparatus with a long sample holder (up to 40 cm) and multiple tubes to measure pressure for monitoring reduced and restored permeability profiles along a core sample. Permeability profiles produced from laboratory flooding experiments are used as input parameters for a hydrodynamic simulator which accounts for distribution of permeability in the formation near-wellbore zone using a cylindrical grid with very fine cells (about few millimeters) around the well.

However, if particles are captured very heavily, as is typical for a drilling fluid filtered through a core, it is difficult to determine permeability profile by measuring pressure drop at different parts of the core samples. First, this method makes it practically impossible to distinguish between the effects of an external filter cake and a packed wall zone on permeability in a near-tip zone of the core sample (at a core sample end exposed to the drilling mud or other fluid). Secondly, because of the narrow low-permeability packed wall zone, tubes should be spaced very closely to each other (about a few millimeters) for measuring pressure drop. It limits tube sizes which can be used for conducting the test.

Changes in pressure drop along the core are due to the effects caused by two mechanisms: changes of relative permeability of the basic phase (oil, gas) caused by filtrate and changes in absolute permeability caused by contaminant plugging some of the pores. Contributions made by these mechanisms in reduction (“damage”) of permeability are important; however, it is impossible to distinguish between them without involving additional measurements.

Russian Patent RU2525093 describes a method for determining changes in formation near-wellbore zone properties (porosity, permeability and saturation) under the effect of a drilling mud. The method is implemented as a combination of mathematic modeling and laboratory flooding experiments; it is proposed to use a bulk concentration profile of mud particles invaded into the core to exactly determine packed wall zone parameters and obtain porosity and permeability profiles. In order to obtain the bulk concentration profile of the particles invaded into the core, the patent proposes to use X-ray computed microtomography data after the flooding experiment. However, this method cannot be applied to low-contrast components. Besides, resolution of at least 2-3 mkm per voxel (voxel is the smallest element of a square 3D image) is required to exactly determine the bulk concentration profile for the solids which invaded into the core. It imposes stiff constraints on a maximum size of the scanned area and results in a significant time necessary to be spent scanning and processing the acquired data.

### SUMMARY

The disclosure provides for determining a profile of modified parameters (porosity, conductive fluid saturation) in a porous medium sample after exposure to a contaminant through measurements of electrical resistivity; the electrical resistivity is measured in different parts of the porous medium sample during a flooding experiment when the contaminant solution is injected into the sample.

According to the claimed method, an initial saturation of a sample of the porous medium is provided by an electrically conductive fluid or an electrically non-conductive fluid, or both the electrically conductive fluid and the electrically non-conductive fluid. First measurements of electrical resistivity in at least two places along the sample of the porous medium are carried out by electrodes disposed in the at least two places of the sample. Then, a flooding experiment is carried out, the flooding experiment comprises injection of a contaminant solution into the sample of the porous medium. Second measurements of electrical resistivity are carried out in the same places of the sample as in the first measurements, the second measurements are carried out during or after the flooding experiment. A saturation profile S_{f} of the sample is determined by formula:

$${( \frac{{S}_{f}}{{S}_{w \_ 0}} )}^{n} = \frac{{R}_{f}}{{R}_{w}} \frac{{R}_{t}}{{R}_{t}^{0}}$$

where S_{w}_{_}₀ is saturation of different places of the sample with the electrically conductive fluid, R_{f} is electrical resistivity of the filtrate of the contaminant solution, R_{w} is electrical resistivity of the electrically conductive fluid, Rₜ⁰ is the measured electrical resistivity during the first measurements before the flooding experiment, Rₜ is the measured electrical resistivity during the second measurements during or after the flooding experiment. A ratio of a modified porosity to an initial porosity is determined by formula

$${( \frac{{φ}_{d}}{{φ}_{0}} )}^{m} = \frac{{R}_{f}}{{R}_{w}} \frac{{R}_{t}^{0}}{{R}_{t}} {{S}_{w \_ 0}^{n} ( 1 - {S}_{oil\_res} )}^{- n}$$

where φ₀—the initial porosity of the porous medium, φ_{d}—the modified porosity of the porous medium, Sₒᵢₗ_{_}ᵣₑₛ—a residual saturation with the non-conductive fluid, m and n—empirical parameters for the given type of the porous medium.

According to one of the embodiments, the electrical resistivity of the conductive fluid is measured.

According another embodiment of the disclosure, the empirical parameters m and n for the given type of the porous medium are obtained from a handbook or from a statistical analysis of laboratory test data.

The residual saturation of the non-conductive fluid is a known typical value for the given type of the porous medium; it can be determined by a separate laboratory experiment involving displacement of the non-conductive fluid by the conductive fluid in a similar porous medium sample.

According to one more embodiment, a pressure drop in different places of the sample is continuously measured during the flooding experiment when the contaminant solution is injected into the porous medium sample and a flow rate of the contaminant solution injected into the sample is measured. Based on the measured pressure drop and the measured contaminant solution flow rate, a permeability profile can be determined.

Based on the modified permeability profile, an additional profile can be produced for a bulk concentration of contaminant components invaded into the sample. The obtained bulk concentration profile of the invaded contaminant components and the determined permeability profile are used to determine packed wall zone parameters and calculate modified properties of the formation near-wellbore zone.

According to another embodiment of the disclosure, the initial porosity of the porous medium sample is measured before the flooding experiment and the measured initial electrical resistivity Rₜ⁰ is used for adjustment of empirical parameter m.

The porous medium sample can be a rock core sample. In this case, a drilling mud is used as a contaminant solution, the core sample is initially saturated with oil and water in accordance with the reservoir conditions.

According to one more embodiment, in order to measure the electrical resistivity, a porous medium sample is placed into a sample holder of a device used for the flooding experiment; the sample holder having at least two electrodes placed along the sample. After the first measurements of electrical resistivity in different places of the sample a profile of initial porosity of the sample is determined by the formula:

$${φ}_{0}^{m} = a \frac{{R}_{w}}{{R}_{t}^{0}} {S}_{w}^{- n} ,$$

where φ₀^{m} is initial porosity of the porous medium sample, a, m and n are empirical parameters for the given type of the porous medium, Rₜ⁰ is electrical resistivity in different places of the sample before the flooding experiment, R_{w} is electrical resistivity of the conductive fluid, S_{w}⁻ⁿ is a porous medium conductive fluid saturation coefficient. In this case, the second measurements of electrical resistivity are carried out in the same places of the sample as during the first measurements; the second measurements are carried out continuously during the flooding experiment, then the modified porosity profile is calculated by the formula:

$${φ}_{d} = {{φ}_{0} [ \frac{{R}_{f}}{{R}_{w}} \frac{{R}_{t}^{0}}{{R}_{t}} {{S}_{w \_ 0}^{n} ( 1 - {S}_{oil \_ res} )}^{- n} ]}^{\frac{1}{m}}$$

The empirical parameters a, m and n for the given type of the porous medium can be obtained from a handbook or from a statistical analysis of laboratory test data.

The residual non-conductive fluid saturation is determined by resistivity Rₜ* measured in different places of the sample Rₜ* flushed by the filtrate during the flooding experiment:

$${( 1 - {S}_{oil \_ res} )}^{- n} = \frac{{R}_{t}^{*}}{{R}_{t}^{0}} \frac{{R}_{w}}{{R}_{f}}$$

The porous medium sample can be a rock core sample. In this case, a drilling mud is used as the contaminant solution, the core sample is initially saturated with oil and water in accordance with the reservoir conditions.

After the flooding experiment, a fluid or gas can be injected through the same sample of the porous medium; in this case, the fluid or gas should be injected at the end opposite to the end where the contaminant solution has been injected.

Based on the profile of the bulk concentration of the contaminant components invaded into the sample, a volume ratio σ_{fc}, occupied by a pack of contaminant particles can be calculated:

$${σ}_{fc} = \frac{σ}{1 - {φ}_{fc}}$$

where φ_{fc} is the porosity of the contaminant particle pack determined in a separate experiment.

### BRIEF DESCRIPTION OF DRAWINGS

Those skilled in the art should more fully appreciate advantages of various embodiments of the present disclosure from the following “Detailed Description,” discussed with reference to the drawings summarized immediately below.

FIG. 1 shows a diagram of a sample holder for measuring a pressure drop and electrical resistivity in different places of a core;

FIG. 2 shows a dynamic pattern of changing normalized electrical resistivity of two sequential parts of the core during injection of bentonite clay mud in concentration of 10 g/l in aqueous solution of sodium chloride NaCl; and

FIG. 3 shows a schematic of determining resistivity profile along the core, whereby the porous medium sample (core) before and after the flooding experiment is placed in a special device with multiple electrodes.

### DETAILED DESCRIPTION

According to various embodiments of the disclosure, modifications in porosity and saturation of a porous medium are determined by changes in electrical resistivity.

The law relating electrical resistivity with porosity and saturation of the porous medium is given by:

Rₜ=a R_{w}φ^{-m}S_{w}⁻ⁿ (1)

where Rₜ is electrical resistivity of a porous medium sample saturated with a conductive fluid and a non-conductive fluid; R_{w} is electrical resistivity of the conductive fluid saturating the porous medium sample (normally, water); φ is porosity of the porous medium sample; S_{w} is porous medium sample saturation coefficient with the conductive fluid (normally, water saturation coefficient); a, m and n are empirical parameters, constant for the given type of the porous medium (for example, a rock core sample).

If applied to shales and in order to account for temperature and pressure effects, the law (1) is supplemented by various corrections, see, for example, Vendelshtein B. Yu., Rezvanov R. A. Geophysical methods of determining oil and gas reservoir properties (used for reserve evaluation and drafting field development plan). Moscow: Nedra, 1978, Chapter 2, p. 64-67; Log interpretation principles/applications by Schlumberger. 1989, Chapter 2, p. 2-8, 2-9.

However, invasion of contaminant solid components (different slurries, drilling mud, etc.) into a porous medium is normally accompanied by development of a packed wall zone and reductions in porosity and permeability of the porous medium. According to the law (1), changes in porosity result in changes in electrical resistivity of the porous medium. Changes of permeability at known injection rate during the flooding experiment can be determined by changes in pressure drop in the given part of the porous medium sample.

Thus, by combining pressure drop measurements and electrical resistivity measurements in different places of the porous medium sample during the flooding experiment with contaminant injection can provide further information about the packed wall zone structure, allows for determining conductive fluid saturation profile, porosity and permeability profiles. Besides, unlike tubes used for measuring a pressure drop, electrodes can be spaced quite densely and very close to each other and to the end of the porous medium sample without adding extra costs for equipment.

The obtained profile of modified (damaged) porosity can be converted into a bulk concentration profile of the contaminant components invaded into the sample (see, for example, patent RRF2525093):

σ=φ₀−φ_{d} (2)

where σ is a volume ratio of contaminant components in unit volume of the porous medium (“bulk concentration”), φ₀ is initial porosity of the porous medium sample, φ_{d} is modified (“damaged”) porosity of the porous medium sample.

Using the volume ratio of the contaminant components per unit volume of the porous medium σ, one can calculate volume ratio σ_{fc} occupied by the pack made of contaminant particles:

$${σ}_{fc} = \frac{σ}{1 - {φ}_{fc}} \qquad ( 3 )$$

where φ_{fc} is the porosity of the pack made of contaminant particles (the porosity of the inner filter cake).

The method is implemented as follows.

A porous medium sample is selected. It can be a bulk porous medium, a ceramic filter, or a rock core sample.

If necessary, electrical resistivity of a conductive fluid is measured (if the core is used, it is resistivity of formation water R_{w}), which will be used later for initial saturation of the porous medium sample. A contaminant solution is then prepared for testing (for example, a drilling mud for core) according to the predefined recipe by adding to a continuous phase (a drilling mud base) an appropriate soluble and insoluble additives,

Electrical resistivity of a contaminant filtrate R_{f} is determined either by measuring resistivity of the continuous phase (the drilling mud base) when all soluble additives are dissolved, or by passing the prepared contaminant solution through a filter paper and measuring electrical resistivity of the leak-off fluid.

The tested porous medium sample is initially saturated with either the conductive fluid (for example, water) or with the conductive fluid and some non-conductive fluid (for example, in case of studying core—water with saturation coefficient S_{w}_{_}₀ and oil with saturation coefficient Sₒᵢₗ_{_}₀ according to the in-situ conditions), or the sample is partly saturated with the conductive fluid (for example, in case of core with water with saturation coefficient S_{w}_{_}₀ and gas according to the in-situ conditions).

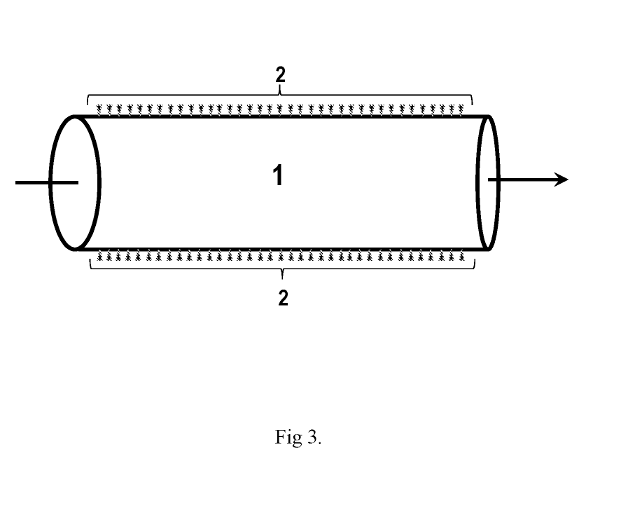

A first measurement of electrical resistivity Rₜ⁰ is taken in different places of the sample along its length; for this purpose, the porous medium sample can be placed in a special device with multiple electrodes (at least two electrodes) placed along the sample (for example, as described in U.S. Pat. No. 4,907,448). FIG. 3 shows a schematic used for measuring resistivity along the sample, where 1 is the sample, 2 is a sleeve with multiple electrodes placed along the sample.

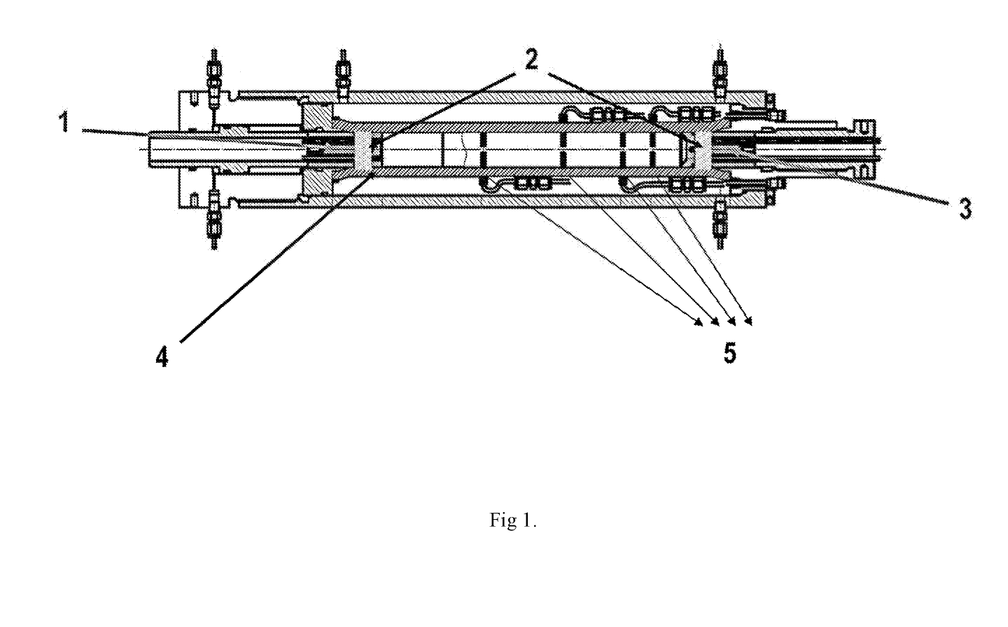

According to another embodiment, a porous medium sample is placed in a special sample holder of the filtration device with at least two electrodes placed along the core as shown on FIG. 1, where 1 is an output plunger, 2 is insulators, 3 is an input plunger, 4 is a dielectric sleeve, and 5 are points where four ring electrodes are located for measuring electrical resistivity of the core and tubes for measuring pressure drop.

A flooding experiment is conducted involving injection of the contaminant solution through the porous medium sample. During or after the flooding experiment, a second measurement of resistivity is taken at the same points where the first measurement has been taken. For the second resistivity measurement the porous medium sample can be again placed in the special device with multiple electrodes. If the special sample holder is used for the flooding experiment, the second electrical resistivity measurement is taken continuously throughout the flooding experiment.

Using the law (1) and the known empirical parameters a, m and n, a rock saturation profile with the conductive fluid can be defined; a reduced porosity profile can be defined based on the electrical resistivity profile obtained during the first and second resistivity measurements. Empirical parameters a, m and n for the given type of the porous medium can be taken from a handbook or determined by a statistical analysis of laboratory test data obtained by measurements taken on a set of investigated porous medium samples (in the case of a core, on representative samples of core from a given reservoir, see Recommended Procedures for Studying Oil and Gas Reservoir Properties using Physical and Petrographic Methods, Moscow, VNIGRI, 1978).

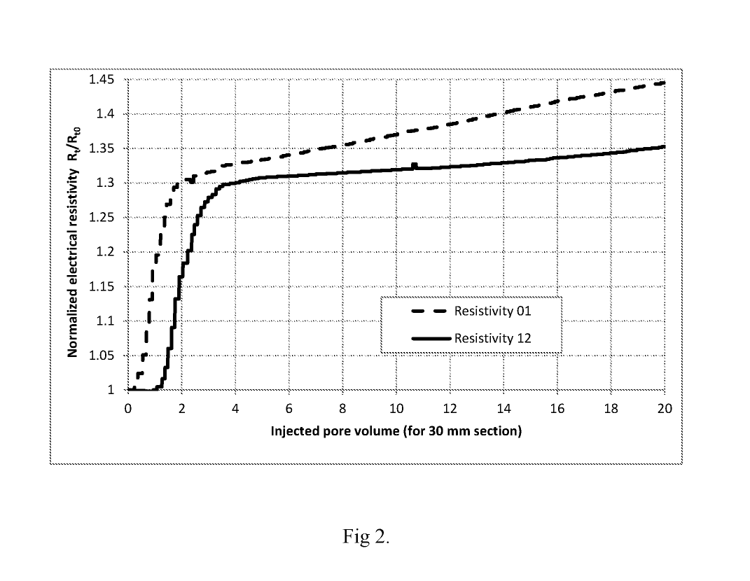

FIG. 2 shows an example of changes of normalized electrical resistivity (Rₜ₀ is an initial electrical resistivity of the corresponding part of the core) of two sequential parts of the core, with diameter 3 cm, during injection of bentonite clay in 1.8% sodium chloride brine. The core sample was fully pre-saturated with 2.5% sodium chloride brine. R_01 is near-tip (input end) part of the core with length 3 cm, R_02 is is the part of the core behind it (farther away from the input end). A sharp rise of electrical resistivity of core (area 1) corresponds to an approaching front of the less conductive contaminant, while a slow rise of electrical resistivity (area 2) corresponds to a gradual decrease in core porosity caused by build-up of clay particles in the pore space.

Profile of rock saturation with contaminant filtrate S_{f} in the areas with sharp increase of resistivity caused by invasion of filtrate into such areas of the core (area 1 on FIG. 2) is determined by the formula:

$${( \frac{{S}_{f}}{{S}_{w \_ 0}} )}^{n} = \frac{{R}_{f}}{{R}_{w}} \frac{{R}_{t}}{{R}_{t}^{0}}$$

where S_{w}_{_}₀ is an initial saturation coefficient of the porous medium sample with the conductive fluid (in this example, S_{w}_{_}₀=1), R_{f} is electrical resistivity of the contaminant filtrate (R_{f}−0.31 Ohm·m), R_{w} is electrical resistivity of the formation water (R_{w}=0.23 Ohm·m), Rₜ⁰ is electrical resistivity in different places of the sample before the flooding experiment (in this example, this value changes little and is equal to Rₜ⁰≈2.9 Ohm·m), Rₜ−actual electrical resistivity (Ohm·m) in the same places of the sample as during the flooding experiment.

A profile of a ratio between modified (damaged) porosity to the initial porosity is determined by electrical resistivity at the gradual change stage, after displacement of the initial saturating fluid with the contaminant filtrate (area 2 on FIG. 2) using the formula:

$${( \frac{{φ}_{d}}{{φ}_{0}} )}^{m} = \frac{{R}_{f}}{{R}_{w}} \frac{{R}_{t}^{0}}{{R}_{t}} {{S}_{w \_ 0}^{n} ( 1 - {S}_{oil \_ res} )}^{- n}$$

where φ₀ is initial porosity of the porous medium (in this example, this value changes little and is equal to φ₀≈0.25), φ_{d} is modified (“damaged”) porosity of the medium, S_{oil res} is residual saturation of the non-conductive fluid (in this example Sₒᵢₗ_{_}ᵣₑₛ=0), m and n are empirical parameters for the given type of the porous medium.

Residual saturation of the non-conductive fluid Sₒᵢₗ_{_}ᵣₑₛ is a known typical value for the given type of the porous medium. It can also be determined by a separate laboratory experiment involving displacement of the non-conductive fluid by the conductive fluid in a similar porous medium sample. If a sample holder is used in the flooding experiment device, residual saturation with non-conductive fluid can also be determined based on electrical resistivity Rₜ* measured in the porous medium sample part flushed by the filtrate during the flooding experiment:

$${( 1 - {S}_{oil \_ res} )}^{- n} = \frac{{R}_{t}^{*}}{{R}_{t}^{0}} \frac{{R}_{w}}{{R}_{f}}$$

An initial porosity profile φ₀ along the sample axis can be determined using the law (1), known empirical parameters a, m, n, known initial saturation of the sample with the conductive fluid (for example, water with saturation coefficient S_{w 0}) and the resistivity obtained during the first resistivity measurement in different places of the porous medium sample:

$${φ}_{0}^{m} = a \frac{{R}_{w}}{{R}_{t}^{0}} {S}_{w}^{- n} ,$$

Corrections can be introduced in the law (1) to account for shale content of the core and effects of pressure and temperature during the flooding experiment; measured electrical resistivity of the saturating fluid and the filtrate will be adjusted to account potential temperature changes when resistivity measurements have been taken.

After the flooding experiment involving exposure of the porous medium sample to the contaminant solution, a fluid or gas can be injected through the same porous medium sample; in this case, the fluid or gas should be injected at the end opposite to the end where the contaminant solution has been injected.

During the flooding experiment, a pressure drop can be measured continuously in different places of the porous medium sample. Based on the registered pressure drop, a permeability profile can be produced.

Before the flooding experiment with injection of the contaminant solution, the porous medium sample can be saturated with a continuous phase (for example, drilling mud base). In this case, changes of electrical resistivity are caused only by porosity changes.

The obtained profile of modified (damaged) porosity can be converted into a bulk concentration profile of the contaminant components invaded into the sample using the expression (2).

The profile of bulk concentration of the contaminant components invaded into the sample and permeability obtained from the experiments can also be used for determining the packed wall zone properties and predicting modifications of properties of the formation near-wellbore zone according to patent RU2525093.

A correction can be introduced in the filtrate resistivity for filtrate mixing in the porous medium (for example, core) with residual conductive fluid (for example, formation water S_{w}_{_}ᵣₑₛ) (see, for example, Vendelshtein B. Yu., Rezvanov R. A., Geophysical Methods of Determining Oil and Gas Reservoir Properties (used for reserve evaluation and drafting field development plan). Moscow: Nedra, 1978, Chapter 2, p. 80):

$${R}_{f \_ w} = \frac{{R}_{f}}{z ( {R}_{f} \text{/} {R}_{w} - 1 ) + 1}$$

where R_{f}_{_}_{w} is electrical resistivity of the zone containing a mixture of filtrate and residual conductive fluid; z is a mixing factor characterizing the share of conductive pore volume occupied by a residual conductive fluid with resistivity R_{w}. Mixing factor z is defined in a separate experiment involving injection of the investigated contaminant into a porous medium sample, similar to the investigated porous medium sample and fully saturated with the conductive fluid (formation water R_{w}), which is used for saturating the investigated porous medium sample.

Before conducting the flooding experiment, initial porosity of the porous medium sample can be determined (for example, according to a standard method, GOST 26450.1-85. Rocks. Methods for determining reservoir properties. A method for determining effective porosity coefficient by fluid saturation. USSR 1985). Using the measured initial porosity of the porous medium sample and measured initial resistivity Rₜ⁰, parameter m in the law (1) is adjusted.

1. A method for determining modifications of porous medium parameters under the effect of a contaminant, the method comprising:
providing an initial saturation of a sample of the porous medium by using an electrically conductive fluid, an electrically non-conductive fluid, or both;
carrying out first measurements of electrical resistivity in at least two places along the sample of the porous medium, wherein the measurements are made by electrodes disposed in the at least two least two places along the sample;
carrying out a flooding experiment, wherein the flooding experiment comprises injection of the contaminant solution in the sample of the porous medium;
carrying out second measurements of electrical resistivity in the same places of the sample as in the first measurements, wherein the second measurements are carried out during or after the flooding experiment by the electrodes disposed in the at least two least two places along the sample;
determining a saturation profile S_{f} of the sample by a filtrate of the contaminant solution using the following relationship:
$${( \frac{{S}_{f}}{{S}_{w \_ 0}} )}^{n} = \frac{{R}_{f}}{{R}_{w}} \frac{{R}_{t}}{{R}_{t}^{0}}$$
where S_{w}_{_}₀ is saturation of different places of the sample with the electrically conductive fluid, R_{f} is electrical resistivity of the filtrate of the contaminant solution, R_{w} is electrical resistivity of the electrically conductive fluid, Rₜ⁰ is the measured electrical resistivity during the first measurements before the flooding experiment, and Rₜ is the measured specific electrical resistivity during the second measurements during or after the flooding experiment, and
determining a ratio of a modified porosity to an initial porosity using the following relationship:
$${( \frac{{φ}_{d}}{{φ}_{0}} )}^{m} = \frac{{R}_{f}}{{R}_{w}} \frac{{R}_{t}^{0}}{{R}_{t}} {{S}_{w \_ 0}^{n} ( 1 - {S}_{oil \_ res} )}^{- n}$$
wherein φ₀ is the initial porosity of the porous medium, φ_{d} is the modified porosity of the porous medium, Sₒᵢₗ_{_}ᵣₑₛ is a residual saturation with the non-conductive fluid, and m and n are empirical parameters for the given type of the porous medium.

2. The method of claim 1, comprising measuring of the electrical resistivity of the conductive fluid.

3. The method of claim 1, wherein the empirical parameters m and n for the given type of the porous medium are obtained from a handbook or from a statistical analysis of laboratory test data.

4. The method of claim 1, wherein the residual saturation with the non-conductive fluid is a known value typical for the given type of the porous medium.

5. The method of claim 1, wherein the residual saturation with the non-conductive fluid is determined by a separate laboratory experiment with displacement of the non-conductive fluid from the similar porous medium sample by the conductive fluid.

6. The method of claim 1, comprising continuously measuring of a pressure drop in different places of the sample during the flooding experiment and a flow rate of the contaminant solution injected into the sample.

7. The method of claim 6, comprising calculating a permeability profile based on the measured pressure drop and the measured contaminant solution flow rate.

8. The method of claim 1, comprising determining a profile of a bulk concentration of contaminant components invaded into the sample based on the modified porosity profile.

9. The method of claim 7, wherein a profile of a bulk concentration of contaminant components invaded into the sample is determined based on the modified porosity profile, the determined bulk concentration profile of the invaded contaminant components and the calculated permeability profile are used to determine packed wall zone parameters and calculate modified parameters of a formation near-wellbore zone.

10. The method of claim 1, wherein the initial porosity of the porous medium sample is measured before the flooding experiment, and the measured initial electrical resistivity value Rₜ⁰ is used to adjust the empirical parameter m.

11. The method of claim 1, wherein the porous medium sample is a rock core sample and the contaminant solution is a drilling mud.

12. The method of claim 1, wherein the core sample is initially saturated with oil and water according to reservoir conditions.

13. The method of claim 1,
wherein for measuring electrical resistivity, the porous medium sample is placed into a sample holder of a device for the flooding experiment, the sample holder having at least two electrodes placed along the sample, after the first measurements of electrical resistivity in the at least two places along the sample a profile of the initial porosity of the sample is determined by the formula:
$${φ}_{0}^{m} = a \frac{{R}_{w}}{{R}_{t}^{0}} {S}_{w}^{- n} ,$$
wherein φ₀^{m} is the initial porosity of the porous medium sample, a, m and n are empirical parameters for the given type of the porous medium, Rₜ⁰ is electrical resistivity in different places of the sample before the flooding experiment, R_{w} is the electrical resistivity of the conductive fluid, S_{w}⁻ⁿ is the coefficient of porous medium saturation with the conductive fluid,
wherein the second measurements of electrical resistivity are carried out continuously during the flooding experiment in the same places of the sample as during the first measurements, and the modified porosity profile is calculated using the following relationship:
$${φ}_{d} = {{φ}_{0} [ \frac{{R}_{f}}{{R}_{w}} \frac{{R}_{t}^{0}}{{R}_{t}} {{S}_{w \_ 0}^{n} ( 1 - {S}_{oil \_ res} )}^{- n} ]}^{\frac{1}{m}}$$

14. The method of claim 13, wherein the empirical parameters a, m and n for the given type of the porous medium are obtained from a handbook or from a statistical analysis of laboratory test data.

15. The method of claim 13, wherein the residual non-conductive fluid saturation e is determined by resistivity Rₜ* measured in different places of the sample Rₜ* flushed by the filtrate during the flooding experiment using the following relationship:
$${( 1 - {S}_{oil \_ res} )}^{- n} = \frac{{R}_{t}^{*}}{{R}_{t}^{0}} \frac{{R}_{w}}{{R}_{f}}$$

16. The method of claim 13, wherein the porous medium sample is a rock core sample and the contaminant solution is a drilling mud.

17. The method of claim 13, wherein the core sample is initially saturated with oil and water according to reservoir conditions.

18. The method of claim 13, wherein after the flooding experiment, a fluid or gas is injected through the same sample of the porous medium, the injection is carried out at the end opposite to the end where the contaminant solution has been injected.

19. The method of claim 8, wherein the determined profile of the bulk concentration of the contaminant components invaded into the sample is used for calculating a volume share σ_{fc}, occupied by the pack of contaminant particles:
$${σ}_{fc} = \frac{σ}{1 - {φ}_{fc}}$$
wherein φ_{fc} is the porosity of the pack of the contaminant particles.
